(19) United States
(12) Patent Application Publication
(10) Pub. No.: US 2021/0320684 A1
(43) Pub. Date: Oct. 14, 2021

(54) INFORMATION PROCESSING DEVICE, INFORMATION PROCESSING METHOD, AND PROGRAM

(71) Applicant: SONY CORPORATION, TOKYO (JP)

(72) Inventor: YUJI IDE, TOKYO (JP)

(21) Appl. No.: 17/250,435

(22) PCT Filed: May 16, 2019
(86) PCT No.: PCT/JP2019/019513

§ 371 Date: Jan. 21, 2021

(30) Foreign Application Priority Data
Jul. 31, 2018 (JP) 2018-143764

(51) Int. Cl. H04B 1/401; G10L 25/84; G10L 25/81; G10L 15/22; G10L 13/02

(52) U.S. Cl. CPC H04B 1/401; G10L 25/84; G10L 13/02; G10L 15/22; G10L 25/81

(57) ABSTRACT

An utterance detection unit 232 detects an utterance period by an utterance detection unit on the basis of an input voice signal supplied from a microphone 31. A background sound generation unit 241 generates a background sound signal according to an utterance period detection result of the utterance detection unit. A voice synthesis unit 242 performs a synthesis process using the background sound signal generated by the background sound generation unit 241 to generate an output voice signal and outputs the same to a speaker 32. The control unit 26 sets a detection period of the utterance detection unit 232 on the basis of an operation signal in response to a user operation generated by an operation switch 33, and transmits the input voice signal of the utterance period from a transmission unit 211 of a communication unit 21, for example. A background sound indicated by the output voice signal makes it possible to easily determine whether or not it is in a voice transmission state.

### TECHNICAL FIELD

This technology relates to an information processing device, an information processing method, and a program, and this makes it possible to easily determine a communication operation state.

### BACKGROUND ART

As disclosed in Patent Document 1, the conventional wireless machine has a push to talk (PTT) function, and it is in a voice transmission state when the PTT switch is turned on. Furthermore, the wireless machine is equipped with a voice operation transmission (VOX) function that turns on the PTT switch when a voice signal is detected so that it may be put into the voice transmission state even in a case where the PTT switch cannot be operated.

### CITATION LIST

### Patent Document

Patent Document 1: Japanese Patent Application Laid-Open No. 2012-099999

### SUMMARY OF THE INVENTION

### Problems to be Solved by the Invention

By the way, it is not possible to determine whether a PTT switch is in an on-state or an off-state without touching or visually observing the PTT switch. Furthermore, it is not possible to determine whether or not the VOX function is operating without checking a switch state and a function setting status.

Therefore, it is an object of this technology to provide an information processing device, an information processing method, and a program capable of easily determining whether or not it is in a voice transmission state.

### Solutions to Problems

A first aspect of this technology is an information processing device provided with:

an utterance detection unit that detects an utterance period on the basis of an input voice signal;

a background sound generation unit that generates a background sound signal according to an utterance period detection result of the utterance detection unit;

a voice synthesis unit that performs a synthesis process using the background sound signal generated by the background sound generation unit to generate an output voice signal; and a control unit that sets a detection period of the utterance detection unit and performs a transmission process of the input voice signal on the basis of an operation signal in response to a user operation.

In this technology, the utterance detection unit detects the utterance period on the basis of, for example, the input voice signal indicating a voice collected by a microphone of a headset. The background sound generation unit generates the background sound signal according to the utterance period detection result of the utterance detection unit, generates an utterance background sound signal in the utterance period, and generates a non-utterance background sound signal different from the utterance background sound signal in a non-utterance period. For example, the utterance background sound signal and the non-utterance background sound signal are different noise signals or melody sound signals, or signals at different signal levels. Furthermore, the utterance background sound signal may be generated by using the input voice signal. A voice synthesis unit performs a synthesis process using the background sound signal generated by the background sound generation unit to generate the output voice signal. For example, the voice synthesis unit performs synthesis of a voice signal received by a communication unit that performs communication of the input voice signal and the background sound signal generated by the background sound generation unit and outputs the same to a speaker of the headset. The control unit sets the detection period of the utterance detection unit and performs the transmission process of the input voice signal on the basis of the operation signal generated in response to the user operation in the input unit or the operation signal generated in response to the user operation by the operation switch provided on the headset.

The control unit turns on or off a push to talk (PTT) function on the basis of the operation signal and makes an on-state period a detection period in the utterance detection unit, a background sound signal generation period in the background sound generation unit, and a transmission operation period in the communication unit. In this case, the background sound generation unit makes a signal level of the utterance background sound signal lower than that of the non-utterance background sound signal, for example, the lowest. Furthermore, the control unit turns on or off a voice operation transmission (VOX) function on the basis of the operation signal and makes an on-state period a detection period in the utterance detection unit and a background sound signal generation period in the background sound generation unit, and makes an utterance period detected by the utterance detection unit a transmission operation period in a communication unit. In this case, the background sound generation unit makes a signal level of the non-utterance background sound signal lower than that of the utterance background sound signal, for example, the lowest.

A second aspect of this technology is an information processing method provided with:

detecting an utterance period by an utterance detection unit on the basis of an input voice signal;

generating a background sound signal by a background sound generation unit according to an utterance period detection result of the utterance detection unit;

performing a synthesis process using the background sound signal generated by the background sound generation unit by a voice synthesis unit to generate an output voice signal; and

allowing a control unit to set a detection period of the utterance detection unit and perform a transmission process of the input voice signal on the basis of an operation signal in response to a user operation.

A third aspect of this technology is a program that allows a computer to execute a transmission control of an input voice signal, the program that allows the computer to execute:

a procedure of detecting an utterance period on the basis of the input voice signal;

a procedure of generating a background sound signal according to an utterance period detection result;

a procedure of performing a synthesis process using the generated background sound signal to generate an output voice signal; and

a procedure of setting a detection period in which the utterance period is detected and performing a transmission process of the input voice signal on the basis of an operation signal in response to a user operation.

Note that, the program of the present technology is the program which may be provided by a storage medium and a communication medium provided in a computer-readable form, for example, a storage medium such as an optical disk, a magnetic disk, and a semiconductor memory, or a communication medium such as a network to a general-purpose computer capable of executing various program codes, for example. By providing such program in the computer-readable form, processing according to the program is realized on the computer.

### Effects of the Invention

According to this technology, an utterance period is detected on the basis of an input voice signal, and a background sound signal is generated according to a detection result of the utterance period. Furthermore, an output voice signal is generated by a synthesis process using the generated background sound signal. Moreover, a detection period in which the utterance period is detected is set on the basis of an operation signal in response to a user operation, and an input voice signal of the utterance period is transmitted from a communication unit. Therefore, a background sound indicated by the output voice signal makes it possible to easily determine whether or not it is in a voice transmission state. Note that the effect described in the present specification is illustrative only; the effect is not limited thereto and there may also be an additional effect.

### BRIEF DESCRIPTION OF DRAWINGS

FIG. 1 is a view illustrating a configuration of a system.

FIG. 2 is a view illustrating a configuration of a first mode.

FIG. 3 is a flowchart illustrating an operation of the first mode.

FIG. 4 is a view illustrating an operation example of a first embodiment.

FIG. 5 is a view illustrating a configuration of a second mode.

FIG. 6 is a flowchart illustrating an operation of the second mode.

FIG. 7 is a view illustrating an operation example of a second embodiment.

FIG. 8 is a view illustrating a display screen of an information processing device 20.

### MODE FOR CARRYING OUT THE INVENTION

Hereinafter, a mode for carrying out the present technology is described. Note that the description is given in the following order.

1. Configuration of system

2. Configuration of first embodiment of information processing device

3. Operation of first embodiment of information processing device

4. Configuration of second embodiment of information processing device

5. Operation of second embodiment of information processing device

6. Variation

<1. Configuration of System>

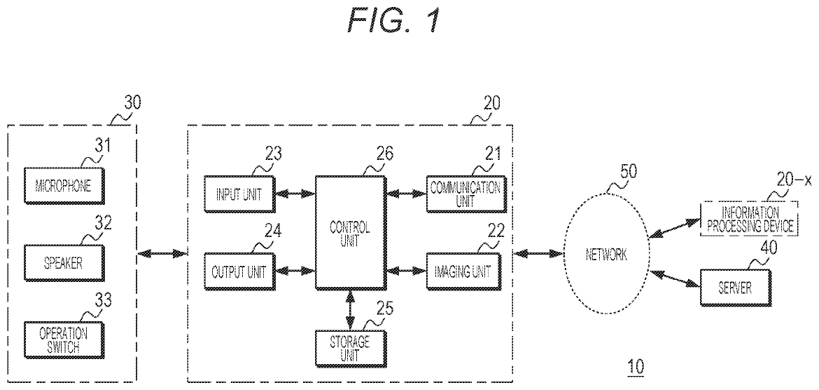

FIG. 1 illustrates a configuration of a system using an information processing device of the present technology. A system 10 is formed by using an information processing device 20 and a server 40, and the information processing device 20 and the server 40 are connected to each other via a network 50. Furthermore, a headset 30 may be connected to the information processing device 20.

The headset 30 is provided with a microphone 31, a speaker 32, and an operation switch 33. The microphone 31 collects a voice uttered by a user who wears the headset 30, converts the same into a voice signal, and outputs the same to the information processing device 20. The speaker 32 converts an output voice signal supplied from the information processing device 20 into a voice and outputs the same. The operation switch 33 outputs an operation signal corresponding to a user operation to the information processing device 20 to turn on or off a function assigned to the operation switch 33. For example, in a case where a push switch that performs a momentary operation is used as the operation switch 33, the information processing device 20 switches the assigned function from an off-state to an on-state or from the on-state to the off-state each time the operation switch 33 is operated.

The information processing device 20 is, for example, a smartphone, and includes a communication unit 21, an imaging unit 22, an input unit 23, an output unit 24, a storage unit 25, and a control unit 26.

The communication unit 21 includes a wireless LAN unit that performs communication conforming to a wireless LAN standard, a public network connection unit that performs communication by using a mobile phone line and the like. The communication unit 21 performs communication with the server 40 in accordance with, for example, the Internet protocol. The communication unit 21 transmits information generated by the information processing device 20, for example, the voice signal supplied from the headset 30 and the like to the server 40. Furthermore, the communication unit 21 receives information transmitted from the server 40 and outputs the same to the output unit 24 and the storage unit 25.

The imaging unit 22 includes an imaging optical system including an imaging element and an imaging lens, an image signal processing unit and the like. As the imaging element, a charge coupled device (CCD) image sensor and a complementary metal oxide semiconductor (CMOS) image sensor are used, for example. An image signal generated by the imaging unit 22 is output to the output unit 24, the storage unit 25, or the server 40 and the like via the communication unit 21.

The input unit 23 is formed by using a touch panel, a microphone and the like. The input unit 23 generates an operation signal corresponding to a user operation on the touch panel and outputs the same to the control unit 26, for example. Furthermore, the input unit 23 obtains a voice from the user with the microphone. Furthermore, the input unit 23 performs reception control of the voice signal supplied from the headset 30.

The output unit 24 is formed by using a display element, a speaker and the like. As the display element, for example, a liquid crystal display (LCD) or an organic light-emitting diode (OLED) and the like is used. Under the control of the control unit 26, the output unit 24 displays a captured image obtained by the imaging unit 22, a video content, text information, a menu screen, various types of setting information and the like, and outputs a voice such as a voice content and a conversation. Furthermore, the output unit 24 generates an output voice signal and outputs the same to the headset 30.

The storage unit 25 stores an application program for performing various operations on the information processing device 20, content data and the like.

The control unit 26 includes a central processing unit (CPU), a read only memory (ROM), a random access memory (RAM) and the like. The read only memory (ROM) stores various programs executed by the central processing unit (CPU). The random access memory (RAM) stores information such as various parameters. The CPU executes the various programs stored in the ROM or the storage unit 25 and controls each unit so that the information processing device 20 performs a desired operation in response to the user operation and the like on the basis of the operation signal generated by the input unit 23. For example, the control unit 26 controls the communication unit 21, the input unit 23, and the output unit 24 so as to perform voice communication with a desired information processing device 20-x, for example, by using a push to talk (PTT) function and a voice operation transmission (VOX) function on the basis of the operation signal.

The server 40 mediates wired or wireless communication between the information processing device 20 and another information processing device 20-x connected to the same via the network 50. For example, the server 40 transmits the voice signal transmitted from the information processing device 20 to the information processing device 20-x being a transmission destination specified by the information processing device 20. Furthermore, the server 40 transmits the voice signal transmitted from the information processing device 20-x to the information processing device 20 being a transmission destination specified by the information processing device 20-x.

<2. Configuration of First Mode of Information Processing Device>

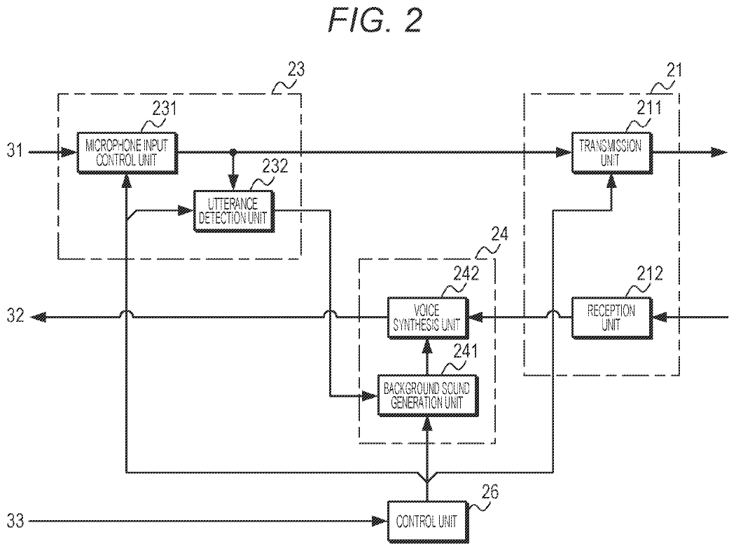

FIG. 2 illustrates a configuration of a first mode of the information processing device. Note that FIG. 2 illustrates a configuration of a functional block regarding the voice communication using the push to talk (PTT) function in the information processing device 20.

The communication unit 21 includes a transmission unit 211 and a reception unit 212, and the input unit 23 includes a microphone input control unit 231 and an utterance detection unit 232. Furthermore, the output unit 24 includes a background sound generation unit 241 and a voice synthesis unit 242.

The transmission unit 211 of the communication unit 21 transmits the voice signal supplied from the microphone input control unit 231 of the input unit 23 to the server 40 while indicating the transmission destination specified by a control signal from the control unit 26. The reception unit 212 outputs a received voice signal to the voice synthesis unit 242 of the output unit 24.

The microphone input control unit 231 of the input unit 23 controls reception of the voice signal supplied from the microphone 31 of the headset 30, for example, on the basis of the control signal from the control unit 26. In a case of receiving the voice signal, the microphone input control unit 231 outputs the voice signal supplied from the microphone 31 to the utterance detection unit 232 and the transmission unit 211 of the communication unit 21. The utterance detection unit 232 performs an utterance detection operation on the basis of the control signal from the control unit 26, detects an utterance period by using the voice signal supplied from the microphone 31, and outputs an utterance detection result to the background sound generation unit 241 of the output unit 24.

The background sound generation unit 241 of the output unit 24 performs a background sound generation operation on the basis of the control signal from the control unit 26, and generates a background sound according to the utterance detection result. For example, the background sound generation unit 241 generates different background sound signals for the utterance period and a non-utterance period. The background sound signal may be any background sound signal capable of being distinguished from a conversation sound; for example, a signal of a noise sound and a melody sound and the like is used. Furthermore, the different background sound signals for the utterance period and the non-utterance period may be the signals of different types of noise sound or melody sound, or may be the signals of the same type of sound at different signal levels. Furthermore, if the voice signal supplied from the microphone 31 is used as the background sound signal for the utterance period, it becomes possible to confirm the type of transmitted voice. Furthermore, in a case where the voice signal supplied from the microphone 31 is used as the background sound signal for the utterance period, it is possible to process the voice signal so that it becomes clear that this is an utterance period background sound to generate the background sound signal. Note that the different background sound signals in the present technology include a case where a signal level is “0” only in any one of the utterance period and the non-utterance period. The background sound generation unit 241 outputs the generated background sound signal to the voice synthesis unit 242. The voice synthesis unit 242 performs synthesis of the received voice signal supplied from the reception unit 212 and the background sound signal generated by the background sound generation unit 241 to generate the output voice signal. The voice synthesis unit 242 outputs the generated output voice signal to, for example, the speaker 32 of the headset 30.

The control unit 26 turns on or off the push to talk (PTT) function on the basis of the operation signal from the operation switch 33 of the headset 30, for example, and makes an on-state period a detection period in the utterance detection unit, a background sound signal generation period in the background sound generation unit, and a transmission operation period in the communication unit. That is, in the period in which the PTT is in the on-state, the control unit 26 allows the microphone input control unit 231 to receive the voice signal supplied from the microphone 31 and supply the same to the transmission unit 211, and allows the transmission unit 211 to transmit the voice signal received by the microphone input control unit 231 to the server 40 while specifying the transmission destination thereof. Furthermore, in the period in which the PTT is in the on-state, the control unit 26 allows the utterance detection unit 232 and the background sound generation unit 241 to operate to generate the different background sound signals for the utterance period and the non-utterance period and to output the same to the speaker 32.

<3. Operation of First Mode of Information Processing Device>

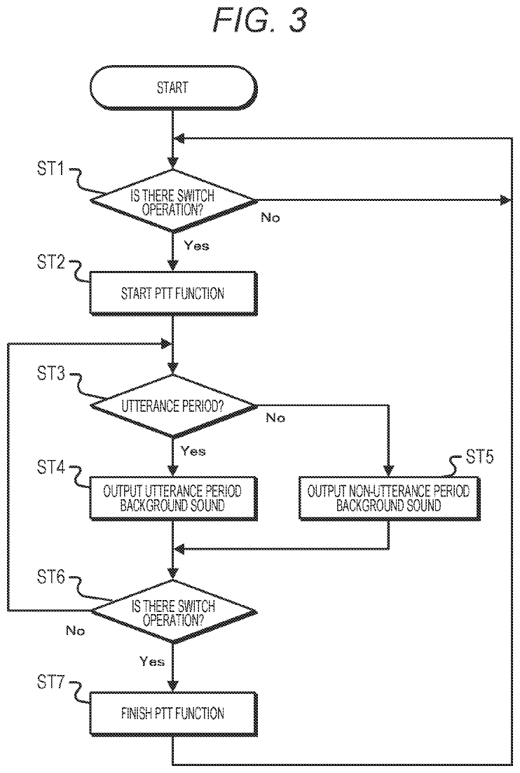

FIG. 3 is a flowchart illustrating an operation of a first embodiment. At step ST1, the information processing device determines whether or not the switch operation is performed. In a case where the control unit 26 of the information processing device 20 determines that the switch operation is performed on the basis of the operation signal from the operation switch 33 of the headset 30, this proceeds to step ST2, and in a case where this determines that the switch operation is not performed, this returns to step ST1.

At step ST2, the information processing device starts the PTT function. The control unit 26 of the information processing device 20 controls the microphone input control unit 231 and starts receiving the voice signal supplied from the microphone 31. Furthermore, the control unit 26 starts the detection operation of the utterance detection unit 232. Moreover, the control unit 26 controls the transmission unit 211 to start a transmission process, thereby transmitting the voice signal supplied from the microphone input control unit 231 to the server 40 while indicating a desired transmission destination, and proceeds to step ST3.

At step ST3, the information processing device determines whether or not it is in the utterance period. The utterance detection unit 232 of the information processing device 20 detects whether or not it is in the utterance period by using the voice signal output from the microphone input control unit 231; when the utterance detection unit 232 detects that the voice signal is output from the microphone input control unit 231, this determines that the utterance period starts. Furthermore, the utterance detection unit 232 determines that the utterance period ends when a period in which the voice signal is not output becomes longer than a predetermined period. The utterance detection unit 232 proceeds to step ST4 when determining that it is in the utterance period, and proceeds to step ST5 when determining that it is not in the utterance period.

At step ST4, the information processing device outputs the utterance period background sound. When determining that it is in the utterance period on the basis of the utterance detection result from the utterance detection unit 232, the background sound generation unit 241 of the information processing device 20 generates an utterance period background sound signal and outputs the same to the voice synthesis unit 242. The voice synthesis unit 242 performs voice synthesis by using the utterance period background sound signal to generate the output voice signal, and outputs the same to the headset 30. The speaker 32 of the headset 30 outputs the utterance period background sound on the basis of the output voice signal and proceeds to step ST6.

At step ST5, the information processing device outputs a non-utterance period background sound. When determining that it is in the non-utterance period on the basis of the utterance detection result from the utterance detection unit 232, the background sound generation unit 241 of the information processing device 20 generates a non-utterance period background sound signal and outputs the same to the voice synthesis unit 242. The voice synthesis unit 242 performs the voice synthesis by using the non-utterance period background sound signal to generate the output voice signal, and outputs the same to the headset 30. The speaker 32 of the headset 30 outputs the non-utterance period background sound on the basis of the output voice signal, and proceeds to step ST6.

It is determined whether or not the switch operation is performed at step ST6. In a case where the control unit 26 of the information processing device 20 determines that the switch operation is performed on the basis of the operation signal from the operation switch 33 of the headset 30, this proceeds to step ST7, and in a case where this determines that the switch operation is not performed, this returns to step ST3.

At step ST7, the information processing device finishes the PTT function. The control unit 26 of the information processing device 20 controls the microphone input control unit 231 to finish receiving the voice signal supplied from the microphone 31. Furthermore, the control unit 26 controls the utterance detection unit 232 to finish the detection operation. Furthermore, the control unit 26 controls the background sound generation unit 241 to finish the background sound generation operation. Moreover, the control unit 26 controls the transmission unit 211 to finish the transmission process, and returns to step ST1.

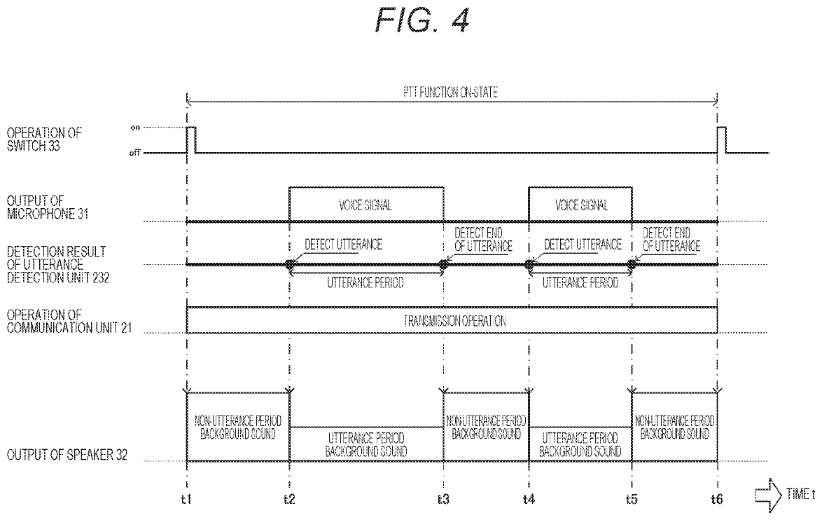

FIG. 4 illustrates an operation example of the first embodiment. Note that a case is illustrated in which the push switch is used as described above as the operation switch 33 of the headset 30, and the PTT function is switched from the off-state to the on-state or from the on-state to the off-state each time the operation switch 33 is operated.

When the operation switch 33 is operated at time point t1, the PTT function is turned on, and the input unit 23 starts receiving the voice signal supplied from the microphone 31 and the utterance detection operation. Furthermore, the communication unit 21 starts a transmission operation of transmitting the voice signal received by the input unit 23. Moreover, since it is in the non-utterance period until the input unit 23 detects the utterance, the background sound generation unit 241 generates the non-utterance period background sound signal, and the speaker 32 to which the output voice signal is supplied from the output unit 24 outputs the non-utterance period background sound. Therefore, the user may determine that the PTT function is in the on-state by the non-utterance period background sound.

Thereafter, the voice signal is input to the input unit 23, and when the utterance detection unit 232 detects the utterance and determines that the utterance period starts at time point t2, the background sound generation unit 241 generates the utterance period background sound signal. Therefore, the output of the speaker 32 to which the output voice signal is supplied from the output unit 24 is switched from the non-utterance period background sound to the utterance period background sound. Therefore, the user may determine that the voice is transmitted by the utterance period background sound.

When the input of the voice signal to the input unit 23 stops, and when the utterance detection unit 232 detects an end of utterance and determines that the utterance period ends at time point t3, the background sound generation unit 241 generates the non-utterance period background sound signal. Therefore, the output of the speaker 32 to which the output voice signal is supplied from the output unit 24 is switched from the utterance period background sound to the non-utterance period background sound. Therefore, the user may determine that the transmission of the voice ends by the non-utterance period background sound.

Thereafter, the voice signal is input to the input unit 23, and when the utterance detection unit 232 detects the utterance and determines that the utterance period starts at time point t4, the output of the speaker 32 is switched from the non-utterance period background sound to the utterance period background sound. Furthermore, when the input of the voice signal to the input unit 23 stops, and the utterance detection unit 232 detects the end of utterance and determines that the utterance period ends at time point t5, the output of the speaker 32 is switched from the utterance period background sound to the non-utterance period background sound.

Furthermore, when the operation switch 33 is operated at time point t6, the PTT function is turned off, and the input unit 23 finishes receiving the voice signal supplied from the microphone 31 and the utterance detection operation. Furthermore, the communication unit 21 finishes the transmission operation of transmitting the voice signal received by the input unit 23. Moreover, the background sound generation unit 241 finishes generating the background sound signal. Therefore, the user may determine that the PTT function is in the off-state because neither the utterance period background sound nor the non-utterance period background sound is output.

In this manner, according to the first embodiment, when the PTT function is in the on-state, the utterance period background sound or the non-utterance period background sound is output. Therefore, it becomes possible to easily determine by the background sound that the PTT function is in the on-state without checking an operation position of the switch or a display screen of the output unit 24. Furthermore, since the utterance period background sound different from the non-utterance period background sound is output in the utterance period, it is possible to easily determine that the voice signal supplied from the microphone 31 is transmitted by the utterance period background sound. Moreover, when the signal level of the utterance background sound signal is made lower than that of the non-utterance background sound signal, for example, when the signal level of the utterance background sound signal is made the lowest, it is possible to make the background sound not noticed when the voice signal supplied from the microphone 31 is transmitted.

<4. Configuration of Second Mode of Information Processing Device>

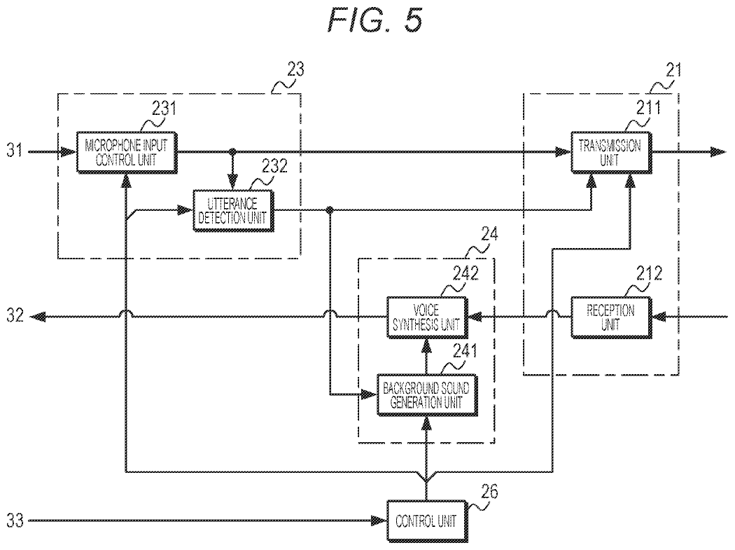

FIG. 5 illustrates a configuration of a second mode of an information processing device. Note that FIG. 5 illustrates a configuration of a functional block regarding voice communication using a voice operation transmission (VOX) function in an information processing device 20.

A communication unit 21 includes a transmission unit 211 and a reception unit 212, and an input unit 23 includes a microphone input control unit 231 and an utterance detection unit 232. Furthermore, an output unit 24 includes a background sound generation unit 241 and a voice synthesis unit 242.

The transmission unit 211 of the communication unit 21 transmits a voice signal supplied from the microphone input control unit 231 of the input unit 23 in an utterance period detected by the utterance detection unit 232 of the input unit 23 to a server 40 while indicating a transmission destination specified by a control signal from a control unit 26. The reception unit 212 outputs a received voice signal to the voice synthesis unit 242 of the output unit 24.

The microphone input control unit 231 of the input unit 23 controls reception of the voice signal generated by a microphone 31 of a headset 30, for example, on the basis of the control signal from the control unit 26. In a case of receiving the voice signal, the microphone input control unit 231 outputs the voice signal supplied from the microphone 31 to the utterance detection unit 232 and the transmission unit 211 of the communication unit 21. The utterance detection unit 232 performs an utterance detection operation on the basis of the control signal from the control unit 52, detects the utterance period by using the voice signal supplied from the microphone 31, and outputs an utterance detection result to the transmission unit 211 of the communication unit 21 and the background sound generation unit 241 of the output unit 24.

The background sound generation unit 241 of the output unit 24 performs a background sound generation operation on the basis of the control signal from the control unit 26, and generates a background sound according to the utterance detection result. For example, the background sound generation unit 241 generates different background sound signals for the utterance period and a non-utterance period. The background sound signal may be any background sound signal capable of being distinguished from a conversation sound; for example, a signal of a noise sound and a melody sound and the like is used. Furthermore, the different background sound signals for the utterance period and the non-utterance period may be the signals of different types of noise sound or melody sound, or may be the signals of the same type of sound at different signal levels. Note that the different background sound signals in the present technology include a case where a signal level is “0”. The background sound generation unit 241 outputs the generated background sound signal to the voice synthesis unit 242. The voice synthesis unit 242 performs synthesis of the received voice signal supplied from the reception unit 212 and the background sound signal generated by the background sound generation unit 241 to generate the output voice signal. The voice synthesis unit 242 outputs the generated output voice signal to, for example, the speaker 32 of the headset 30.

The control unit 26 performs a voice communication control operation using the voice operation transmission (VOX) function, for example, on the basis of the operation signal from the operation switch 33 of the headset 30. The control unit 26 receives the voice signal supplied from the microphone 31 by the microphone input control unit 231 and supplies the same to the transmission unit 211 while the VOX is in the on-state. Furthermore, in the period in which the VOX is in the on-state, the control unit 26 allows the utterance detection unit 232 and the background sound generation unit 241 to operate to generate the different background sound signals for the utterance period and the non-utterance period, and to output the same to the speaker 32. Furthermore, the control unit 26 makes the utterance period detected by the utterance detection unit 232 a transmission operation period of the transmission unit 211 in the period in which the VOX is in the on-state, and transmits the voice signal received by the microphone input control unit 231 in the utterance period to the server 40 while specifying the transmission destination thereof.

<5. Operation of Second Mode of Information Processing Device>

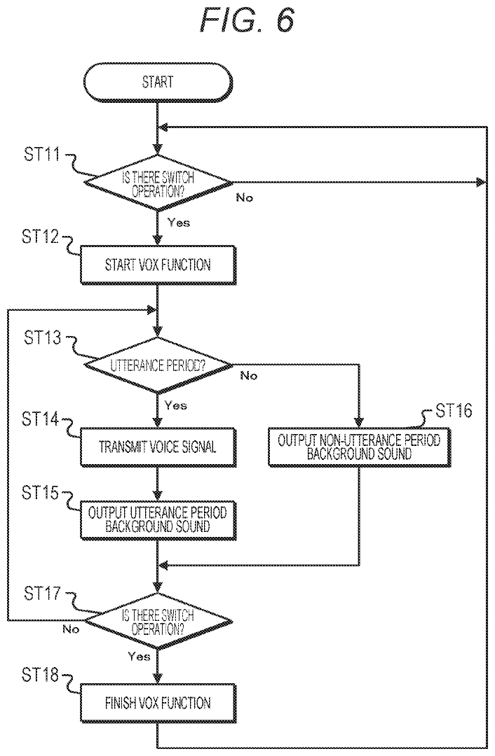

FIG. 6 is a flowchart illustrating an operation of a second embodiment. At step ST11, the information processing device determines whether or not the switch operation is performed. In a case where the control unit 26 of the information processing device 20 determines that the switch operation is performed on the basis of the operation signal from the operation switch 33 of the headset 30, this proceeds to step ST12, and in a case where this determines that the switch operation is not performed, this returns to step ST11.

At step ST12, the information processing device starts the VOX function. The control unit 26 of the information processing device 20 controls the microphone input control unit 231 and starts receiving the voice signal supplied from the microphone 31. Furthermore, the control unit 26 starts the detection operation of the utterance detection unit 232 and proceeds to step ST13.

At step ST13, the information processing device determines whether or not it is in the utterance period. The utterance detection unit 232 of the information processing device 20 detects whether or not it is in the utterance period by using the voice signal output from the microphone input control unit 231. The utterance detection unit 232 determines that the utterance period starts when detecting that the voice signal is output from the microphone input control unit 231, and determines that the utterance period ends when a period in which the voice signal is not output becomes longer than a predetermined period; when determining that it is in the utterance period, this proceeds to step ST14, and when determining that it is not in the utterance period, this proceeds to step ST16.

At step ST14, the information processing device transmits the voice signal. The utterance detection unit 232 and the control unit 26 control the transmission unit 211 to perform the transmission process in the utterance period to transmit the voice signal supplied from the microphone input control unit 231 to a desired transmission destination, then proceeds to step ST15.

At step ST15, the information processing device outputs the utterance period background sound. When determining that it is in the utterance period on the basis of the utterance detection result from the utterance detection unit 232, the background sound generation unit 241 of the information processing device 20 generates an utterance period background sound signal and outputs the same to the voice synthesis unit 242. The voice synthesis unit 242 performs voice synthesis by using the utterance period background sound signal to generate the output voice signal, and outputs the same to the headset 30. The speaker 32 of the headset 30 outputs the utterance period background sound on the basis of the output voice signal, and proceeds to step ST17.

At step ST16, the information processing device outputs a non-utterance period background sound. When determining that it is in the non-utterance period on the basis of the utterance detection result from the utterance detection unit 232, the background sound generation unit 241 of the information processing device 20 generates a non-utterance period background sound signal and outputs the same to the voice synthesis unit 242. The voice synthesis unit 242 performs the voice synthesis by using the non-utterance period background sound signal to generate the output voice signal, and outputs the same to the headset 30. The speaker 32 of the headset 30 outputs the non-utterance period background sound on the basis of the output voice signal, and proceeds to step ST17.

It is determined whether or not the switch operation is performed at step ST17. In a case where the control unit 26 of the information processing device 20 determines that the switch operation is performed on the basis of the operation signal from the operation switch 33 of the headset 30, this proceeds to step ST18, and in a case where this determines that the switch operation is not performed, this returns to step ST13.

At step ST18, the information processing device finishes the VOX function. The control unit 26 of the information processing device 20 controls the microphone input control unit 231 to finish receiving the voice signal supplied from the microphone 31. Furthermore, the control unit 26 controls the utterance detection unit 232 to finish the detection operation. Moreover, the control unit 26 controls the background sound generation unit 241 to finish the background sound generation operation, and returns to step ST11.

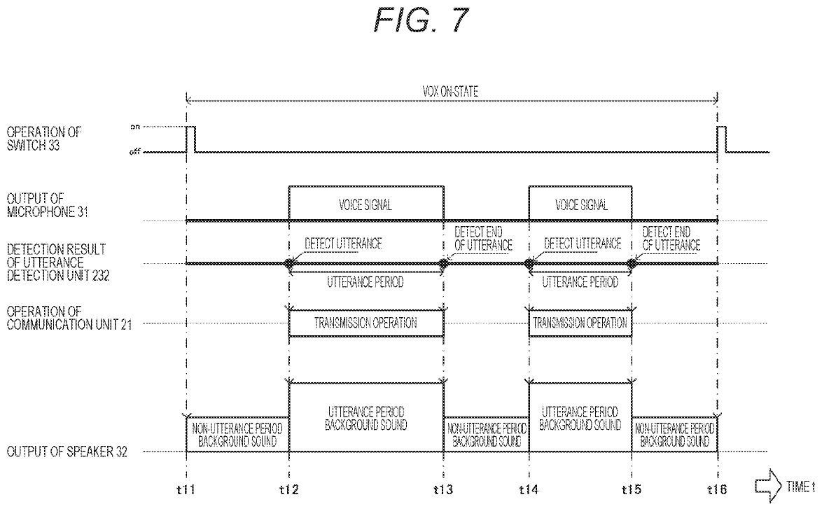

FIG. 7 illustrates an operation example of the second embodiment. Note that a case is illustrated in which the push switch is used as described above as the operation switch 33 of the headset 30, and the VOX function is switched from the off-state to the on-state or from the on-state to the off-state each time the operation switch 33 is operated.

When the operation switch 33 is operated at time point t11, the VOX function is turned on, and the input unit 23 starts receiving the voice signal supplied from the microphone 31 and the utterance detection operation. Moreover, since it is in the non-utterance period until the input unit 23 detects the utterance, the background sound generation unit 241 generates the non-utterance period background sound signal, and the speaker 32 to which the output voice signal is supplied from the output unit 24 outputs the non-utterance period background sound. Therefore, the user may determine that the VOX function is in the on-state by the non-utterance period background sound.

Thereafter, the voice signal is input to the input unit 23, and when the utterance detection unit 232 detects the utterance and determines that the utterance period starts at time point t12, the communication unit 21 starts the transmission operation of transmitting the voice signal received by the input unit 23. Furthermore, the background sound generation unit 241 generates the utterance period background sound signal. Therefore, the output of the speaker 32 to which the output voice signal is supplied from the output unit 24 is switched from the non-utterance period background sound to the utterance period background sound. Therefore, the user may determine that the voice is transmitted by the utterance period background sound.

When the input of the voice signal to the input unit 23 stops, and when the utterance detection unit 232 detects an end of utterance and determines that the utterance period ends at time point t13, the communication unit 21 finishes the transmission operation, and the background sound generation unit 241 generates the non-utterance period background sound signal. Therefore, the output of the speaker 32 to which the output voice signal is supplied from the output unit 24 is switched from the utterance period background sound to the non-utterance period background sound. Therefore, the user may determine that the transmission of the voice ends by the non-utterance period background sound.

Thereafter, the voice signal is input to the input unit 23, and when the utterance detection unit 232 detects the utterance and determines that the utterance period starts at time point t14, the communication unit 21 starts the transmission operation of the voice signal, and the output of the speaker 32 is switched from the non-utterance period background sound to the utterance period background sound. Furthermore, when the input of the voice signal to the input unit 23 stops, and the utterance detection unit 232 detects the end of utterance and determines that the utterance period ends at time point t15, the communication unit 21 finishes the transmission operation, and the output of the speaker 32 is switched from the utterance period background sound to the non-utterance period background sound.

Furthermore, when the operation switch 33 is operated at time point t16, the VOX function is turned on, and the input unit 23 finishes receiving the voice signal supplied from the microphone 31 and the utterance detection operation. Furthermore, the background sound generation unit 241 finishes generating the background sound signal. Therefore, the user may determine that the VOX function is in the off-state because neither the utterance period background sound nor the non-utterance period background sound is output.

In this manner, according to the second embodiment, when the VOX function is in the on-state, the utterance period background sound or the non-utterance period background sound is output, so that it becomes possible to easily determine by the background sound that the VOX function is in the on-state without checking an operation position of the switch or a display screen of the output unit 24. Furthermore, since the utterance period background sound different from the non-utterance period background sound is output in the utterance period, it is possible to easily determine that the voice signal supplied from the microphone 31 is transmitted by the utterance period background sound. Moreover, when the signal level of the non-utterance background sound signal is made lower than that of the utterance background sound signal, for example, when the signal level of the non-utterance background sound signal is made the lowest, it is possible to make an influence of the background sound small when the received voice is listened to in a case where the background sound signal is superimposed on the received voice signal received by the reception unit 212 to generate the output voice signal.

<6. Variation>

Although a case where a PTT function is used is described in the first embodiment described above and a case where a VOX function is used is described in the second embodiment, it is possible that an information processing device has the PTT function and the VOX function and any one of them is selected to be used. In this case, by using different background sounds for the PTT function and the VOX function as a non-utterance period background sound, it becomes possible to easily determine the function that is used by a voice output from a speaker 32.

An utterance detection unit 232 performs a detection operation of utterance and end of utterance to detect an utterance period; by detecting an ambient sound level of a user on the basis of a voice signal from a microphone 31 received by a microphone input control unit 231 and adjusting a signal level of a non-utterance period background sound signal according to the ambient sound level, a background sound generation unit 241 may make a level of the non-utterance period background sound an easy-to-listen level.

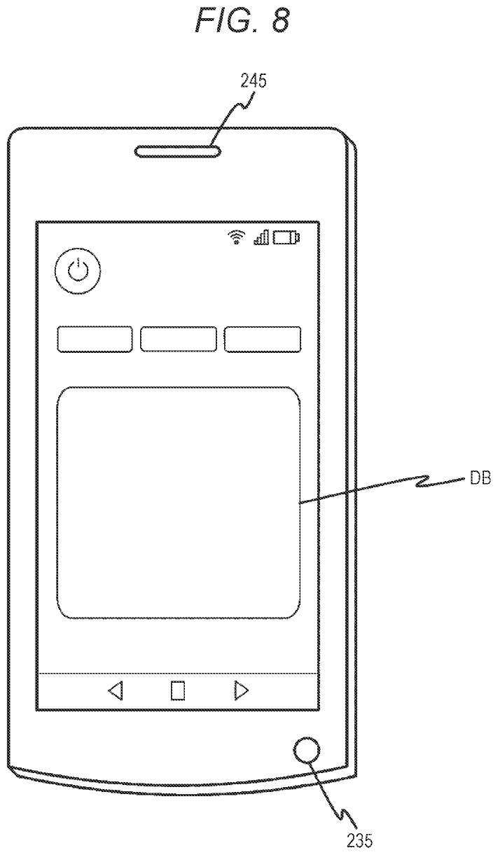

Furthermore, although the PTT function or the VOX function is operated according to a switch operation of an operation switch 33 provided on a headset 30 in the above-described embodiment, this may also be operated according to an operation of a touch panel and the like of an input unit 23 of an information processing device 20. FIG. 8 illustrates a display screen of the information processing device 20. The information processing device 20 is provided with a PTT button display DB on an application screen, for example. Furthermore, the PTT button display DB is displayed, for example, in the center of the screen in an enlarged manner so that it is possible to touch a position of the PTT button display without looking at the display screen. The control unit 26 switches the PTT function from an off-state to an on-state or from the on-state to the off-state each time the position of the PTT button display is touched. Furthermore, it is also possible to provide a VOX button display on the application screen, and the VOX function is switched from an off-state to an on-state or from the on-state to the off-state each time a position of the VOX button display is touched. In this manner, if the information processing device 20 switches the operation of the PTT function and the operation of the VOX function, the operation of the above-described embodiment may be performed even with a headset without a switch.

Furthermore, in a case where an application program may be added to the information processing device 20 as a smartphone and the like, it is not limited to a case where the application program that performs the operation of the embodiment described above is installed in advance, and it is also possible to add the application program to perform the operation of the embodiment described above

Moreover, if the input unit 23 of the information processing device 20 is provided with a microphone 235 and an output unit 24 is provided with a speaker 245, it is possible to perform the operation similar to that of the embodiment described above by using the microphone 235 and the speaker 245 of the information processing device 20 even in a case where the headset is not used. Furthermore, the information processing device 20 is not limited to the smartphone, and may be a feature phone, a wireless communication device and the like.

A series of processing described in the specification may be executed by hardware, software, or a composite configuration of both. In a case where the processing by the software is executed, a program in which a processing sequence is recorded is installed in a memory in a computer incorporated in dedicated hardware and executed. Alternatively, it is possible to install and execute the program in a general-purpose computer capable of executing various processes.

For example, the program may be recorded in advance in a hard disk, a solid state drive (SSD), and a read only memory (ROM) as a recording medium. Alternatively, the program may be temporarily or permanently stored (recorded) in a removable recording medium such as a flexible disk, a compact disc read only memory (CD-ROM), a magneto optical (MO) disk, a digital versatile disc (DVD), a Blu-ray Disc (BD) (registered trademark), a magnetic disk, and a semiconductor memory. Such removable recording medium may be provided as so-called package software.

Furthermore, in addition to be installed from the removable recording medium into the computer, the program may be transferred wirelessly or by wire from a download site to a computer via a network such as a local area network (LAN) or the Internet. In the computer, it is possible to receive the program transferred in this manner and to install the same on a recording medium such as a built-in hard disk.

Note that the effect described in the present specification is illustrative only and is not limited; there may be an additional effect not described. Furthermore, the present technology should not be construed as being limited to the above-described embodiment of the technology. The embodiment of this technology discloses the present technology in the form of illustration, and it is obvious that those skilled in the art may modify or replace the embodiment without departing from the gist of the present technology. That is, in order to determine the gist of the present technology, claims should be taken into consideration.

Furthermore, the information processing device of the present technology may also have the following configuration.

(1) An information processing device provided with:

an utterance detection unit that detects an utterance period on the basis of an input voice signal;

a background sound generation unit that generates a background sound signal according to an utterance period detection result of the utterance detection unit;

a voice synthesis unit that performs a synthesis process using the background sound signal generated by the background sound generation unit to generate an output voice signal; and

a control unit that sets a detection period of the utterance detection unit and performs a transmission process of the input voice signal on the basis of an operation signal in response to a user operation.

(2) The information processing device according to (1),

in which the background sound generation unit generates an utterance background sound signal in the utterance period detected by the utterance detection unit, and generates a non-utterance background sound signal in a non-utterance period.

(3) The information processing device according to (2),

in which the utterance background sound signal and the non-utterance background sound signal are different background sound signals.

(4) The information processing device according to (3),

in which the different background sound signals are different noise signals or melody sound signals.

(5) The information processing device according to (3) or (4),

in which the utterance background sound signal and the non-utterance background sound signal have different signal levels.

(6) The information processing device according to any one of (3) to (5),

in which the utterance background sound signal is generated by using the input voice signal.

(7) The information processing device according to any one of (2) to (6),

in which the control unit turns on or off a push to talk (PTT) function on the basis of the operation signal and makes an on-state period a detection period in the utterance detection unit, a background sound signal generation period in the background sound generation unit, and a transmission operation period in a communication unit that performs communication of the input voice signal.

(8) The information processing device according to (7),

in which the background sound generation unit makes a signal level of the utterance background sound signal lower than a signal level of the non-utterance background sound signal.

(9) The information processing device according to (8),

in which the background sound generation unit makes the signal level of the utterance background sound signal the lowest.

(10) The information processing device according to any one of (2) to (6),

in which the control unit turns on or off a voice operation transmission (VOX) function on the basis of the operation signal and makes an on-state period a detection period in the utterance detection unit and a background sound signal generation period in the background sound generation unit, and makes the utterance period detected by the utterance detection unit a transmission operation period in a communication unit that performs communication of the input voice signal.

(11) The information processing device according to (10),

in which the background sound generation unit makes a signal level of the non-utterance background sound signal lower than a signal level of the utterance background sound signal.

(12) The information processing device according to (11),

in which the background sound generation unit makes the signal level of the non-utterance background sound signal the lowest.

(13) The information processing device according to any one of (1) to (12),

in which the voice synthesis unit performs synthesis of a voice signal received by a communication unit and the background sound signal generated by the background sound generation unit to generate the output voice signal.

(14) The information processing device according to any one of (1) to (13),

in which the input voice signal is a signal indicating a voice collected by a microphone of a headset, and the output voice signal is a signal supplied to a speaker of the headset.

(15) The information processing device according to (14),

in which the operation signal is a signal generated in response to the user operation by an input unit that receives the user operation, or a signal generated in response to the user operation by an operation switch provided on the headset.

### INDUSTRIAL APPLICABILITY

According to an information processing device, an information processing method, and a program according to this technology, an utterance period is detected on the basis of an input voice signal, and a background sound signal is generated according to a detection result of the utterance period. Furthermore, an output voice signal is generated by a synthesis process using the generated background sound signal. Moreover, a detection period in which the utterance period is detected is set on the basis of an operation signal in response to a user operation, and an input voice signal of the utterance period is transmitted from a communication unit. Therefore, a background sound indicated by the output voice signal makes it possible to easily determine whether or not it is in a voice transmission state. Therefore, this is suitable for a device with a PTT function and a VOX function used in a situation in which it is difficult to visually check a switch state and a function setting state.

### REFERENCE SIGNS LIST

10 System
20, 20-x Information processing device
21 Communication unit
22 Imaging unit
23 Input unit
24 Output unit
25 Storage unit
26, 52 Control unit
30 Headset
31, 235 Microphone
32, 245 Speaker
33 Operation switch
40 Server
50 Network
211 Transmission unit
212 Reception unit
231 Microphone input control unit
232 Utterance detection unit
241 Background sound generation unit
242 Voice synthesis unit

1. An information processing device comprising:
an utterance detection unit that detects an utterance period on a basis of an input voice signal;
a background sound generation unit that generates a background sound signal according to an utterance period detection result of the utterance detection unit;
a voice synthesis unit that performs a synthesis process using the background sound signal generated by the background sound generation unit to generate an output voice signal; and
a control unit that sets a detection period of the utterance detection unit and performs a transmission process of the input voice signal on a basis of an operation signal in response to a user operation.

2. The information processing device according to claim 1,
wherein the background sound generation unit generates an utterance background sound signal in the utterance period detected by the utterance detection unit, and generates a non-utterance background sound signal in a non-utterance period.

3. The information processing device according to claim 2,
wherein the utterance background sound signal and the non-utterance background sound signal are different background sound signals.

4. The information processing device according to claim 3,
wherein the different background sound signals are different noise signals or melody sound signals.

5. The information processing device according to claim 3,
wherein the utterance background sound signal and the non-utterance background sound signal have different signal levels.

6. The information processing device according to claim 3,
wherein the utterance background sound signal is generated by using the input voice signal.

7. The information processing device according to claim 2,
wherein the control unit turns on or off a push to talk (PTT) function on a basis of the operation signal and makes an on-state period a detection period in the utterance detection unit, a background sound signal generation period in the background sound generation unit, and a transmission operation period in a communication unit that performs communication of the input voice signal.

8. The information processing device according to claim 7,
wherein the background sound generation unit makes a signal level of the utterance background sound signal lower than a signal level of the non-utterance background sound signal.

9. The information processing device according to claim 8,
wherein the background sound generation unit makes the signal level of the utterance background sound signal the lowest.

10. The information processing device according to claim 2,
wherein the control unit turns on or off a voice operation transmission (VOX) function on a basis of the operation signal and makes an on-state period a detection period in the utterance detection unit and a background sound signal generation period in the background sound generation unit, and makes the utterance period detected by the utterance detection unit a transmission operation period in a communication unit that performs communication of the input voice signal.

11. The information processing device according to claim 10,
wherein the background sound generation unit makes a signal level of the non-utterance background sound signal lower than a signal level of the utterance background sound signal.

12. The information processing device according to claim 11,
wherein the background sound generation unit makes the signal level of the non-utterance background sound signal the lowest.

13. The information processing device according to claim 1,
wherein the voice synthesis unit performs synthesis of a voice signal received by a communication unit that performs communication of the voice signal and the background sound signal generated by the background sound generation unit to generate the output voice signal.

14. The information processing device according to claim 1,
wherein the input voice signal is a signal indicating a voice collected by a microphone of a headset, and
the output voice signal is a signal supplied to a speaker of the headset.

15. The information processing device according to claim 14,
wherein the operation signal is a signal generated in response to the user operation by an input unit that receives the user operation, or a signal generated in response to the user operation by an operation switch provided on the headset.

16. An information processing method comprising:
detecting an utterance period by an utterance detection unit on a basis of an input voice signal;
generating a background sound signal by a background sound generation unit according to an utterance period detection result of the utterance detection unit;
performing a synthesis process using the background sound signal generated by the background sound generation unit by a voice synthesis unit to generate an output voice signal; and
allowing a control unit to set a detection period of the utterance detection unit and perform a transmission process of the input voice signal on a basis of an operation signal in response to a user operation.

17. The information processing method according to claim 16, further comprising:
generating an utterance background sound signal in the utterance period detected by the utterance detection unit and generating a non-utterance background sound signal in a non-utterance period by the background sound generation unit.

18. The information processing method according to claim 16, further comprising:
turning on or off a push to talk (PTT) function on a basis of the operation signal and making an on-state period a detection period in the utterance detection unit, a background sound signal generation period in the background sound generation unit, and a transmission operation period in a communication unit that performs communication of the input voice signal by the control unit.

19. The information processing method according to claim 16, further comprising:
turning on or off a voice operation transmission (VOX) function on a basis of the operation signal and making an on-state period a detection period in the utterance detection unit and a background sound signal generation period in the background sound generation unit, and making the utterance period detected by the utterance detection unit a transmission operation period in a communication unit that performs communication of the input voice signal by the control unit.

20. A program that allows a computer to execute a transmission control of an input voice signal, the program that allows the computer to execute:
a procedure of detecting an utterance period on a basis of the input voice signal;
a procedure of generating a background sound signal according to an utterance period detection result;
a procedure of performing a synthesis process using the generated background sound signal to generate an output voice signal; and
a procedure of setting a detection period in which the utterance period is detected and performing a transmission process of the input voice signal on a basis of an operation signal in response to a user operation.
